(19) United States
(12) Patent Application Publication
(10) Pub. No.: US 2021/0311942 A1
(43) Pub. Date: Oct. 7, 2021

(54) DYNAMICALLY ALTERING A QUERY ACCESS PLAN

(71) Applicant: International Business Machines Corporation, Armonk, NY (US)

(72) Inventors: SHUO LI, BEIJING (CN); Xiaobo Wang, BEIJING (CN); ShengYan Sun, BEIJING (CN); Hong Mei Zhang, BEIJING (CN)

(21) Appl. No.: 16/838,074

(22) Filed: Apr. 2, 2020

(51) Int. Cl. G06F 16/2452; G06F 16/2455; G06F 17/18

(52) U.S. Cl. CPC G06F 16/24524; G06F 17/18; G06F 16/2456

(57) ABSTRACT

A computer-implemented method dynamically changes an access plan during run-time. The method includes, receiving, from a host, a query, that is configured to retrieve a set of data from a database. The method also includes, generating an access plan, the access plan comprising a plurality of commands. The method further includes, creating, for a first command of the plurality of commands, a plurality of mini plans including a first mini plan and a second mini plan. The method includes, analyzing each mini plan of the plurality of mini plans. The method also includes, changing, dynamically and in response to the analyzing, the access plan.

### BACKGROUND

The present disclosure relates to database queries, and, more specifically, to dynamically altering query access plans.

Structured query language (SQL) is a database management language used in relational databases. SQL queries may include a variety of commands such as search, scan, join, etc. Generally, there are multiple methods to obtain data stored in various tables. Database systems, based on the SQL query, generate an access plan to return the data requested in the query. An access is a series of steps configured to efficiently execute the query.

### SUMMARY

Disclosed is a computer-implemented method to dynamically change an access plan during run-time. The method includes, receiving, from a host, a query that is configured to retrieve a set of data from a database. The method also includes, generating an access plan, the access plan comprising a plurality of commands. The method further includes, creating, for a first command of the plurality of commands, a plurality of mini plans including a first mini plan and a second mini plan. The method includes, analyzing each mini plan of the plurality of mini plans. The method also includes, changing, dynamically and in response to the analyzing, the access plan.

Further aspects of the present disclosure are directed to systems and computer program products that are functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 depicts a cloud computing environment according to an embodiment of the present invention.

FIG. 2 depicts abstraction model layers according to an embodiment of the present invention.

FIG. 3 is a block diagram of a DPS according to one or more embodiments disclosed herein.

FIG. 4 is a block diagram of a computing environment suitable for operation of a query manager, in accordance with some embodiments of the present disclosure.

FIG. 5 illustrates a flow chart of an example method to dynamically alter an access plan, in accordance with some embodiments of the present disclosure.

### DETAILED DESCRIPTION

Structured query language (SQL) is a database management language used in relational databases. SQL queries may include a variety of commands such as search, scan, join, etc. Generally, there are multiple methods to obtain data stored in various tables. Database systems, based on the SQL query, generate an access plan to return the data requested in the query. An optimizer may be used to identify what appears to be the most efficient path. Generating a sub-optimal access path can lead to significant performance degradation.

In order to better utilize computing resources, embodiments of the present disclosure dynamically alter the access plan during runtime by replacing relatively less efficient SQL commands with more efficient commands.

The following acronyms may be used below:

API application program interface
ARM advanced RISC machine
CD—compact disc ROM

### ROM

CMS content management system
CoD capacity on demand
CPU central processing unit
CUoD capacity upgrade on demand
DPS data processing system
DVD digital versatile disk
EPROM erasable programmable read-only memory
FPGA field-programmable gate arrays
HA high availability
IaaS infrastructure as a service
I/O input/output
IPL initial program load
ISP Internet service provider
ISA instruction-set-architecture
LAN local-area network
LPAR logical partition
PaaS platform as a service
PDA personal digital assistant
PLA programmable logic arrays
RAM random access memory
RISC reduced instruction set computer
ROM read-only memory
SaaS software as a service
SLA service level agreement
SRAM static random-access memory
WAN wide-area network

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

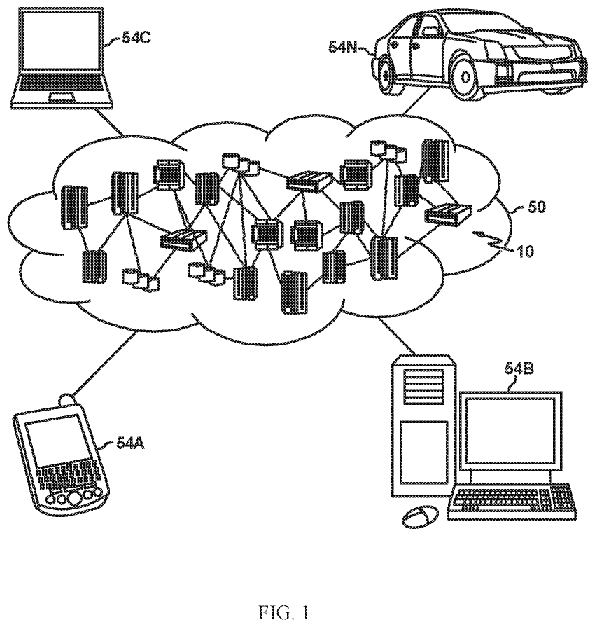

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

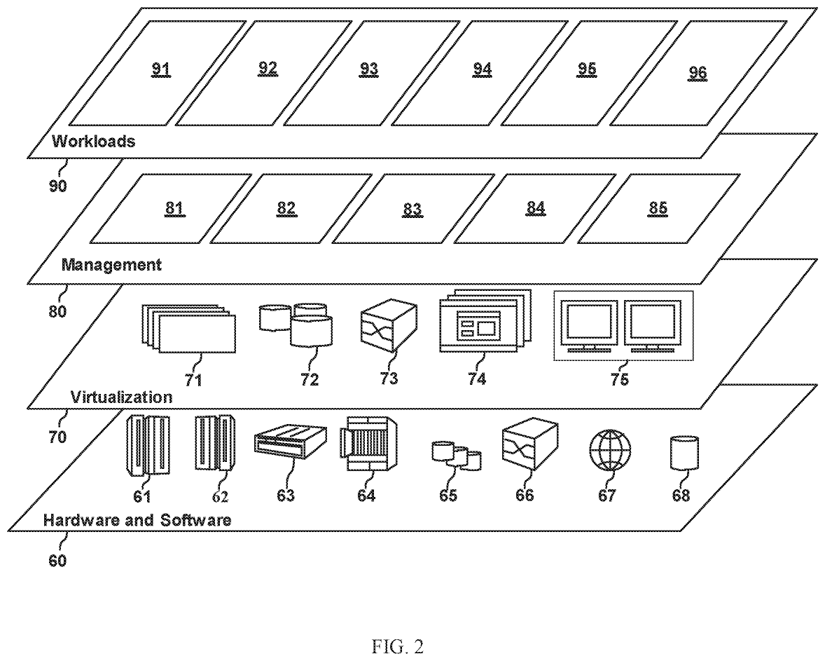

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

### Data Processing System in General

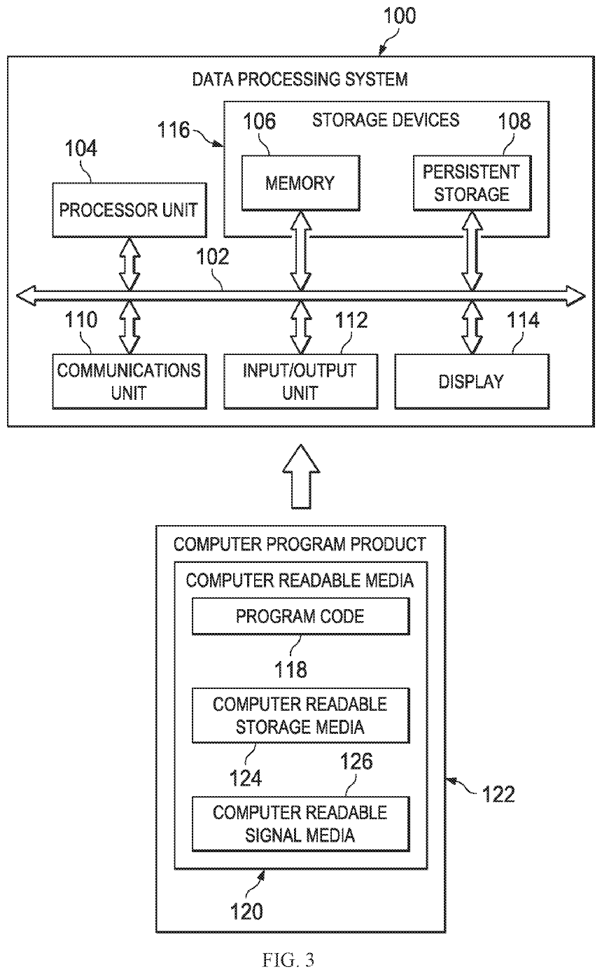

FIG. 3 is a block diagram of an example DPS according to one or more embodiments. The DPS may be used as a cloud computing node 10. In this illustrative example, the DPS 100 may include communications bus 102, which may provide communications between a processor unit 104, a memory 106, persistent storage 108, a communications unit 110, an I/O unit 112, and a display 114.

The processor unit 104 serves to execute instructions for software that may be loaded into the memory 106. The processor unit 104 may be a number of processors, a multi-core processor, or some other type of processor, depending on the particular implementation. A number, as used herein with reference to an item, means one or more items. Further, the processor unit 104 may be implemented using a number of heterogeneous processor systems in which a main processor is present with secondary processors on a single chip. As another illustrative example, the processor unit 104 may be a symmetric multi-processor system containing multiple processors of the same type.

The memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The memory 106, in these examples, may be, for example, a random access memory or any other suitable volatile or non-volatile storage device. The persistent storage 108 may take various forms depending on the particular implementation.

For example, the persistent storage 108 may contain one or more components or devices. For example, the persistent storage 108 may be a hard drive, a flash memory, a rewritable optical disk, a rewritable magnetic tape, or some combination of the above. The media used by the persistent storage 108 also may be removable. For example, a removable hard drive may be used for the persistent storage 108.

The communications unit 110 in these examples may provide for communications with other DPSs or devices. In these examples, the communications unit 110 is a network interface card. The communications unit 110 may provide communications through the use of either or both physical and wireless communications links.

The input/output unit 112 may allow for input and output of data with other devices that may be connected to the DPS 100. For example, the input/output unit 112 may provide a connection for user input through a keyboard, a mouse, and/or some other suitable input device. Further, the input/output unit 112 may send output to a printer. The display 114 may provide a mechanism to display information to a user.

Instructions for the operating system, applications and/or programs may be located in the storage devices 116, which are in communication with the processor unit 104 through the communications bus 102. In these illustrative examples, the instructions are in a functional form on the persistent storage 108. These instructions may be loaded into the memory 106 for execution by the processor unit 104. The processes of the different embodiments may be performed by the processor unit 104 using computer implemented instructions, which may be located in a memory, such as the memory 106.

These instructions are referred to as program code, computer usable program code, or computer readable program code that may be read and executed by a processor in the processor unit 104. The program code in the different embodiments may be embodied on different physical or tangible computer readable media, such as the memory 106 or the persistent storage 108.

The program code 118 may be located in a functional form on the computer readable media 120 that is selectively removable and may be loaded onto or transferred to the DPS 100 for execution by the processor unit 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the DPS 100. In some instances, the computer readable storage media 124 may not be removable from the DPS 100.

Alternatively, the program code 118 may be transferred to the DPS 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or DPS through the computer readable signal media 126 for use within the DPS 100. For instance, program code stored in a computer readable storage medium in a server DPS may be downloaded over a network from the server to the DPS 100. The DPS providing the program code 118 may be a server computer, a client computer, or some other device capable of storing and transmitting the program code 118.

The different components illustrated for the DPS 100 are not meant to provide architectural limitations to the manner in which different embodiments may be implemented. The different illustrative embodiments may be implemented in a DPS including components in addition to or in place of those illustrated for the DPS 100, and/or other components shown in FIG. 1

### Dynamically Altering an SQL Access Plan

Executing SQL queries may involve scanning thousands of entries from multiple tables to identify requested data, and properly managing/displaying/returning the data. The method or order used to obtain and manage the data can have a profound effect on the amount of computing resources used to complete the request. Many modern applications are retrieving data in individual transactions from large database systems. The transactions may be processed multiple times. Any inefficiency in executing the queries may be compounded for each transaction.

Generally, a database manager will generate an access plan based on the structure of the query. The access plan includes a series of operations to obtain sort and merge all the data requested in the query. When generating the access plan, an optimizer may select which types of commands (e.g., loop join v hybrid join, table scan v index scan, etc.) will be used and/or the order (e.g., table 1 then table 2 then table 3, or table 1 then table 3 then table 2, etc.) in which data will be obtained, with the goal of using the least amount of computing resources without comprising the results. Generating a relatively less efficient access plan leads to diminished performance. This productivity loss may be compounded for each sub-optimal query that is performed. However, optimizers may be unable to alter access plans once execution (runtime) has commenced. What appears to be the most efficient access path prior to commencing may be a relatively less efficient path. The relative efficiency potential access plans may differ based on values returned during the query. However, the optimizer may be unable to accurately predict which value will be returned. Thus, embodiments of the present disclosure can alter an access plan during runtime, based on the returned values and other database statistics.

Embodiments of the present disclosure dynamically alter the access path during runtime to increase the efficiency of the query. In some embodiments, an access method may be dynamically switched during runtime. In some embodiments, a join method may be dynamically chosen and/or dynamically altered during runtime. In some embodiments, a join sequence may be dynamically reordered during runtime. In some embodiments, a query manager dynamically alters the access path.

Embodiments of the present disclosure may generate one or more mini plans. A mini plan may be an alternate method (e.g., different access method, different join method, different join sequence, etc.) to complete the query within the generated access path. For example, say an access plan included a table scan of table 2 (T2). Rather than having only the one option, the query manager may generate two mini plans. The first mini plan includes the table scan as initially generated, the second mini plan includes an index scan as an alternative access method to the table scan. Based on a value returned during run-time, the relatively more efficient method (e.g., table scan or index scan), may be executed at the appropriate time. In some embodiments, a command related to the mini plans may be a conditional node. A single query may have several sets of mini plans. For example, say a query includes a join and a fetch command; the query manager may generate mini plans based on the join command, and mini plans based on the fetch command. Said differently, this access plan may have two conditional nodes.

In some embodiments, the access plan is dynamically altered based on results of previous steps of the query. When building the access, the optimizer may use database statistics to guess at which commands may be most efficient. If this guess/estimate is incorrect, the query will use more computing resources than necessary. In some embodiments, the data returned is analyzed and the analysis is used to dynamically switch between mini plans. The switching may be based on one or more conditions that are generated with the mini plans. The conditions may operate as a set point, such that when a condition is met, the access plan is dynamically altered to execute the other mini plan. When the condition is no longer met, the access plan is dynamically switched back to the original mini plan. In some embodiments, the conditions include filter factors. Filter factors may be calculated/retrieved from databases statistics and/or predicates. A predicate is a logical condition being applied to rows in a table (e.g., all rows where X<100).

The aforementioned advantages are example advantages, and embodiments exist that can contain all, some, or none of the aforementioned advantages while remaining within the spirit and scope of the present disclosure.

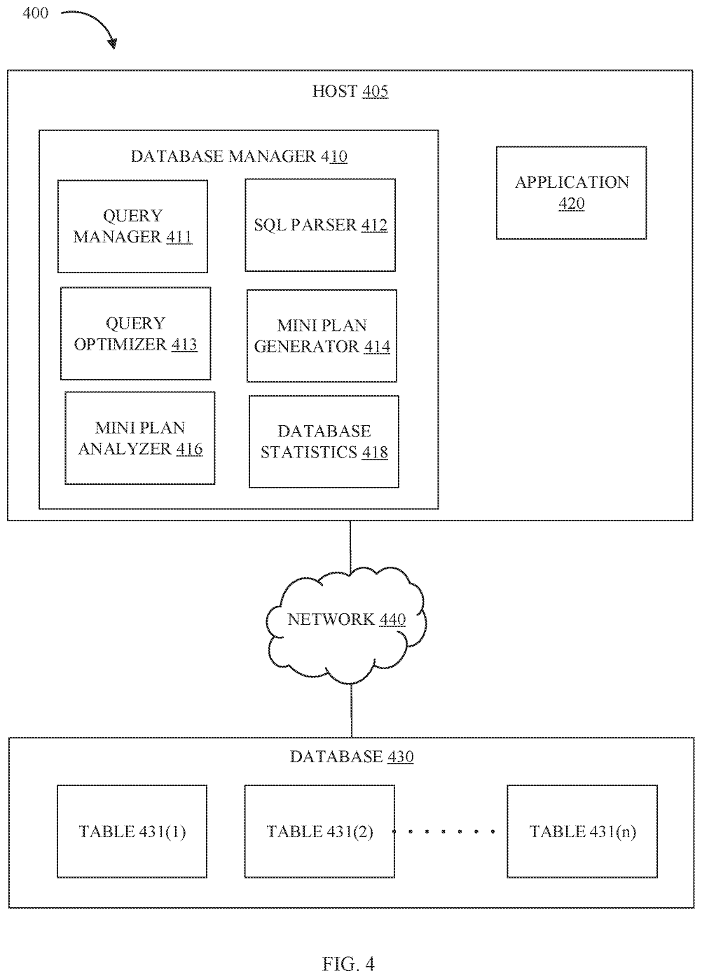

Referring now to various embodiments of the disclosure in more detail, FIG. 4 is a representation of a computing environment 400, which may be, by way of example, the cloud computing environment 50, that is capable of running a query manager in accordance with one or more embodiments of the present disclosure. Many modifications to the depicted environment may be made by those skilled in the art without departing from the scope of the disclosure.

Computing environment 400 includes host 405, database 430, and network 440. Network 440 can be, for example, a telecommunications network, a local area network (LAN), a wide area network (WAN), such as the Internet, or a combination of the three, and can include wired, wireless, or fiber optic connections. Network 440 may include one or more wired and/or wireless networks that are capable of receiving and transmitting data, voice, and/or video signals, including multimedia signals that include voice, data, and video information. In general, network 440 may be any combination of connections and protocols that will support communications between host 405, database 430, and other computing devices (not shown) within computing environment 400. In some embodiments, host 405 and database 430 may include a computer system, such as the data processing system 100 of FIG. 3.

Host 405 can be a standalone computing device, a management server, a web server, a mobile computing device, or any other electronic device or computing system capable of receiving, sending, and processing data. In other embodiments, host 405 can represent a server computing system utilizing multiple computers as a server system, such as in a cloud computing environment. In some embodiments, host 405 represents a computing system utilizing clustered computers and components (e.g., database server computers, application server computers, etc.) that act as a single pool of seamless resources when accessed within computing environment 400. In some embodiments, host 405 includes database manager 410, and application 420.

Database manager 410 can be any combination of hardware and/or software configured to manager database operations. The operations may include storing, retrieving, querying, manipulating, monitoring, and analyzing data along with other similar operations. In some embodiments, database manager 410 includes a database management system (DBMS). In some embodiments, database manager 410 is part of a federated database system. A federated database system can transparently map multiple autonomous database systems into a single federated (combined) database. In some embodiments, a federated database system acts as a virtual database, where there is no actual data integration in the constituent databases. In some embodiments, database manager 410 includes query manager 411, SQL parser 412, query optimizer 413, mini plan generator 414, mini plan analyzer 416, and database statistics 418.

Query manager 411 can be any combination of hardware and/or software configured oversee execution of an SQL query. In some embodiments, query manager 411 includes SQL parser 412, query optimizer 413, mini plan generator 414, and mini plan analyzer 416. However, FIG. 4 depicts them as separate components for discussion purposes.

SQL parser 412 can be any combination of hardware and/or software configured to determine actions to be performed from a query. In some embodiments, SQL parser 412 determines individual commands to complete the query. In some embodiments, SQL parser 412 develops one or more access plans. The access plan may include a stack(set) of commands, where each command is considered a node. Each node, except for the highest node in the tree (e.g., return command) includes one parent node. A node may have one or more child nodes.

Query optimizer 413 can be any combination of hardware and/or software configured to optimize the query (or access plan). Optimizing the access plan includes determining one or more efficient execution mechanisms. A more efficient query may use relatively fewer computing resources. A more efficient query may return the results in a relatively shorter amount of time. In some embodiments, optimizing includes altering the one or more previously generated access plans. The altering may include moving (rearranging) nodes in the access plan (e.g., altering join order). In some embodiments, the optimizing includes changing/adjusting a specific command for a similar command (e.g., table scan for index scan, or merge join for loop join). The optimizer may use database statistics to optimize the query.

In some embodiments, query optimizer 413 outputs a final access plan. The final access plan may be the access plan determined to be the most efficient. In some embodiments, access plan optimization occurs during bind time. Bind time (or compile time) is time prior to accessing data in a database. Bind time may be when the SQL query code is being converted into code executable by database manager 410.

Mini plan generator 414 can be any combination or hardware and/or software configured to generate one or more mini plans in the final access plan. A mini plan includes alternative methods to complete a common function. Mini plans may be considered a conditional node or a conditional command. The conditions for each mini plan may be related to previous results (or received values) from previous steps of the access plan.

In some embodiments, mini plan generator 414 generates mini plans for each command where there is an alternate command to produce a similar result. In some embodiments, mini plans may be generated for each access method, each join method, and/or each join sequence in the access plan. In some embodiments, the mini plan includes one or more conditions (or setpoints) that indicate when to switch between mini plans. The conditions may be based on database statistics, results of each step of the query (a passed in value), and/or on data gathered during runtime (e.g., an index repeat ratio).

Mini plan analyzer 416 can be any combination of hardware and/or software configured analyze mini plans. In some embodiments, mini plan analyzer 416 determines if mini plan conditions are met. In some embodiments, mini plan analyzer 416 operates during runtime of the query.

In some embodiments, mini plan analyzer 416 obtains data from database statistics 418 and/or results of the current query. In some embodiments, miming plan analyzer 416 obtains data from query optimizer 413. The data may be used to calculate filter factors. The data may be used to determine if the mini plan conditions are met.

In some embodiments, mini plan analyzer 416 alters the final access plan. The altering may be in response to determining a mini plan condition (or setpoint) is satisfied. Altering may include selecting an alternate mini plan.

Database statistics 418 can be any combination of hardware and/or software configured to store database statistics. In some embodiments, database statistics 418 track distribution of values in the tables and indexes in the database. In some embodiments, database statistics 418 is updated and maintained by database manager 410. In some embodiments, database statistics 418 includes frequency data. Frequency data represents the relative occurrence of a given value. In some embodiments, database statistics 418 includes histograms. Histograms may represent relative occurrences of a range of values.

Application 420 can be any combination of hardware and/or software that is configured to generate a query. A query can be a request for data and/or information stored in one more tables of or more databases. The databases may be local (e.g., on host 405), or remote (e.g., database 430). In some embodiments, application 420 sends the query to database manager 410. In some embodiments, application 420 is included in database manager 410.

In some embodiments, application 420 is part of a computing device separate from host 405. The computing device may communicate with host 405 via network 440. In some embodiments, the computing device can generate queries, send queries to host 405, and/or receive and display the results of the query.

In some embodiments, the query is generated in SQL. In some embodiments, application 420 displays the results of the query. The results may be returned in an SQL format, and/or as images, graphs, trends, and/or other similar formats.

Database 430 can be any combination of hardware and/or software configured to store data in a database system. In some embodiments, database 430 is part of a federated database system. In some embodiments, database 430 includes two or more databases communicatively connected. In some embodiments, database 430 may be contained within host 405.

In some embodiments, database 430 include table 431(1), table 431(2), through table 431(n), where n is an integer index. Tables 431(1), through 431(n) may be referred to as table 431 in combination or representatively. In some embodiments, each table 431 has one or more associated indices. The index may represent the location of various data contained in table 431.

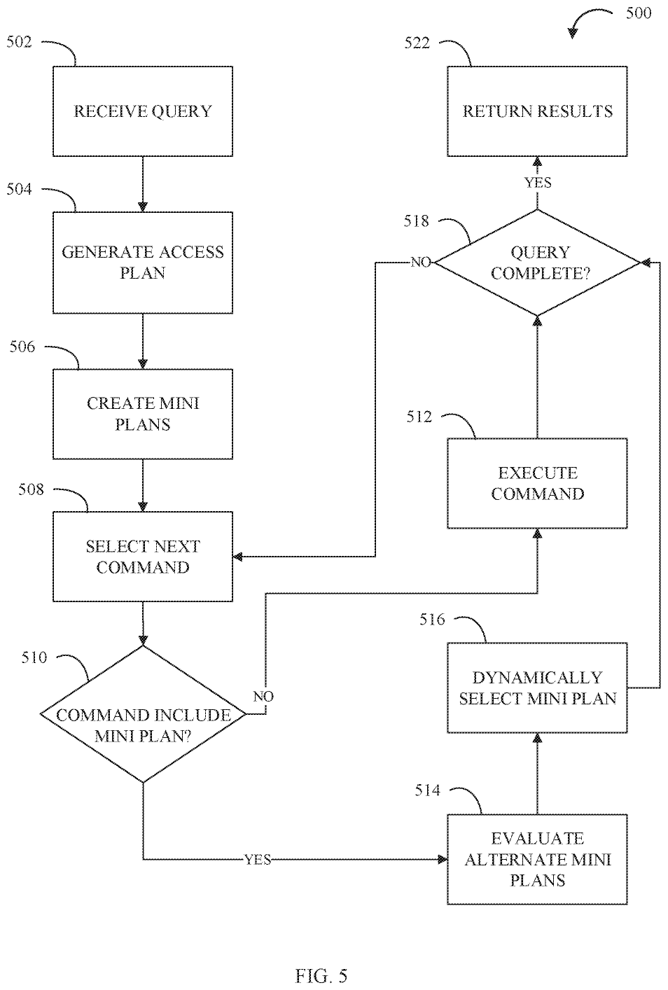

FIG. 5 depicts a flowchart of an example method, method 500, for dynamically altering an access plan during runtime, that can be performed in a computing environment (e.g., computing environment 400 and/or, cloud computing environment 50). One or more of the advantages and improvements described above for generating and monitoring usage patterns may be realized by method 500, consistent with various embodiments of the present disclosure.

Method 500 can be implemented by one or more processors, host 405, database manager 410, query manager 411, application 420, database 430, their subcomponents, and/or a different combination of hardware and/or software. In various embodiments, the various operations of method 500 are performed by one or more of host 405, database manager 410, query manager 411, application 420, database 430, ore their subcomponents. For illustrative purposes, the method 500 will be described as being performed by query manager 411.

At operation 502, query manager 411 receives a query. In some embodiments, the query is received from application 420. In some embodiments, the query is received in SQL. In some embodiments, the query is configured to perform one or more commands on a set of data, wherein the data is stored in database 430. In some embodiments, operation 502 includes parsing the query. The query may be parsed by SQL parser 412.

At operation 504, query manager 411 generates an access plan (or final access plan). Generating the access plan may include generating one or more potential plans and optimizing the potential plans. In some embodiments, the access plan may be generated by one or more of SQL parser 412, and query optimizer 413. In some embodiments, the access plan is based on data stored in database statistics 418. The data may estimate the number of returns (e.g., how many rows meet the query criteria) based on previous queries and other factors. Query optimizer 413 may use the data to select particular instruction types (e.g., table scan versus an index scan). In some embodiments, the data used to generate the access plan is included in the runtime data. This may later be used by query optimizer 413.

At operation 506, query manager 411 generates mini plans. In some embodiments, mini plan generator 414 generates the mini plans (set of mini plans). In some embodiments, a mini plan is generated at each command that includes an access method, a join method, and/or a join sequence. However, it may be impractical to generate a mini plan for the first fetch (or first command), as the results of the first fetch may be used to dynamically change the access plan in later operations.

At operation 508, query manager 411 selects the next (first) command in the access plan. In some embodiments, if the next command is the first command, operation 508 includes commencing runtime. In some embodiments, the next command is based on the access plan. In some embodiments, selecting the next command includes selecting the next node. The command may be one of a data access, data join, and/or other similar commands.

At operation 510, query manager 411 determines if the selected command includes mini plans. In some embodiments, the command includes mini plans based on the access plan generated at operation 504 and the mini plans created at operation 506. In some embodiments, the command includes a mini plan if the command includes an access method, a join method, or a join sequence.

If query manager 411 determines the selected command includes mini plans (510:YES), then query manager 411 proceeds to operation 514. If query manager 411 determines the selected command does not include mini plans (510:NO), then query manager 411 proceeds to operation 512. At operation 512 query manager 411 executes the command. The command is executed as indicated in the access plan. At the completion of operation 512, query manager 411 proceeds to operation 518

At operation 514 query manager 411 evaluates the mini plans. In some embodiments, mini plan analyzer 416 performs the evaluation. The evaluation may be based on results of the previously completed commands. The data passed in from previously completed commands may be compared against database statistics. In some embodiments, the data passed in from previous commands is used a predicate. A predicate can be a logical condition that is applied to one or more rows of a table.

In some embodiments, the evaluation includes identifying a filter factor. A filter factor represents a percentage (or relative amount) of the entries that will be filtered out based on previously returned data. In some embodiments, the filter factor is related to the predicate. For example, a first predicate may limit a fetch to rows with a first value less than a first predicate. This value may correlate to a number of reads required to gather all the data or other system usage. For example, consider query 1. Query 1 is configured to join all rows in a first table and a second table that have a common value of a first column. After fetching the rows with value X from the first table, mini plan analyzer 416 can use database statistics to calculate/estimate a filter factor for the same value in the second table. But the value X cannot be known until the data from the first table is fetched. Database statistics may include a frequency of X in the second table. The frequency may be correlated to the filter factor. If the frequency is above a threshold then a first fetch method (e.g., index scan) may be used to retrieve the data. If the frequency of X is below the threshold, then the access plan is dynamically changed/switched, and a second method (e.g., table scan) may be used to obtain the data. Continuing the example, if query 1 also includes joining rows with a value Y, the process is repeated. The fetch method from the second table may be the same or different as it was for value X, based on the frequency of Y.

At operation 516 query manager 411 dynamically changes (or switches) between mini plans. In some embodiments, the changing is based on the results of the analysis. In some embodiments, the changing is based on the conditions attached generated with the mini plan. The conditions may act like a set point. In some embodiments, the conditions are related to predicates and/or filter factors. The filter factor may be calculated/estimated from database statistics such as frequency. Frequency represents the relative number of occurrences of a value. For example, if there is a first command with a first mini plan and a second mini plan, the first plan may be executed/selected whenever the filter factor (or frequency) is less than 0.30, and the second mini plan whenever the filter factor is greater than or equal to 0.30. Continuing the discussion of query 1, if the first value X has a filter factor or 0.05, then the first mini plan may be selected (e.g., index scan of the second table). If table one includes a second value Y with a filter factor of 0.35, then the access plan will dynamically change to the second mini plan (e.g., table scan of the second table).

In some embodiments, the filter factor is based on histograms. Consider query 2 as an example. Query 2 is configured to join rows in a first table and a second table, where a value of the first column in the first table is greater than the value of the first column in the second table, and the value of the second column in the first table is less than the value of the second column in the second table. Also, the second table includes two associated indexes, one based on the first column and one based on the second column. The first mini plan may include scanning the first index, and the second mini plan scanning the second index. The filter factor may be obtained from (at least in part) the histogram.

In some embodiments, the condition may be related to system performance. This may include ratios, read, rows returned and other similar data. For example, consider query 3. Query 3 is similar to query 1, except the mini plans are related to the join method. The first mini plan joins the first table and the second table by a nest loop join, and the second mini plan uses a hybrid join. For query 3, the mini plan condition may be the repeat ratio of the index. If the repeat ratio of the index increases above a setpoint (condition), then the access plan dynamically switches to a merge the hybrid join from the nest loop join. Further, if the ratio then decreases below set point, the merge method may be dynamically switched back to the first mini plan. The switching may occur whenever the condition is met/changes. If the first table had 100 rows, the first mini plan may be used for rows 1-10, 25-30, and 46-75 and the second mini plan for rows 11-24, 31-45, and 76-100.

In some embodiments, the condition may be related to estimations. The estimations may be used by query optimizer 413 when generating the access plan. For example, consider query 4. Query 4 is similar to query 3 except the second mini plan is a sort merge join, and there is a sparse index. When query optimizer 413 selected the nest loop join as the first mini plan, it estimated a certain number of rows would be included, or alternatively, assumed a specific filter factor would occur. As soon as the number of qualifying rows exceeds the estimation, the access plan will dynamically switch the second mini plan to complete the merger. The estimation could be sent from query optimizer 413 to min plan analyzer 416 when runtime commenced.

In some embodiments, the condition may be based on anticipated workload. The anticipated workload may be calculated in response to obtaining some results of the query. For example, consider query 5. Query 5 is configured to join rows from a first table (T1), a second table (T2), and a third table (T3) where a value of a first column in T1 equals the corresponding column in T2, and the value of a second column in T1 equals the corresponding column in T3, with a predicate on the value of T3. The first mini plan is to join the tables in the order T1 then T2, then T3. The second mini plan is the join the tables in the order T1 then T3, then T2. The anticipated work can be calculated by the number of rows of table 1 plus the number of rows of table 2 multiplied by the number of qualifying rows from table 1. T1+T2(T1*P) where P is the predicate (a number between 0 and 1). This represents the number of reads that must be accomplished to complete the merge. The condition for query 5 can be to select the mini plan with the fewest number of reads. If the second mini plan has less read that the first mini plan, then the access plan will dynamically switch the join sequence to the second mini plan.

At operation 518, query manager 411 determines if the query is complete. The query is complete if all commands in the access plan have been executed. At operation 522, query manager 411 returns the query results to the requestor (e.g., host 405, application 420, etc.).

### Computer Technology and Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, from a host, a query that is configured to retrieve a set of data from a database;
generating an access plan, the access plan comprising a plurality of commands;
creating, for a first command of the plurality of commands, a plurality of mini plans including a first mini plan and a second mini plan;
analyzing each mini plan of the plurality of mini plans; and
changing, dynamically and in response to the analyzing, the access plan.

2. The method of claim 1, wherein:
the first mini plan is configured to execute the first command by a first method;
the second mini plan is configured to execute the first command by a second method;
the access plan is configured to execute the first mini plan; and
in response to changing the access plan, the access plan is configured to execute the second mini plan.

3. The method of claim 1, the method further comprising:
determining a first condition is satisfied, wherein:
the creating the plurality of mini plans comprises establishing the first condition; and
the changing of the access plan is in response to the first condition being satisfied.

4. The method of claim 3, wherein the analyzing each mini plan further comprises:
obtaining a passed-in value, wherein the passed-in value is a result of a previously executed command from the plurality of commands; and
retrieving, from the database, a set of statistics related to the passed-in value.

5. The method of claim 4, wherein:
the first condition is a filter factor;
the set of statistics includes a frequency of the passed-in value in a first table; and
the first condition is satisfied when a frequency of the passed-in value exceeds the filter factor.

6. The method of claim 4, wherein:
the set of statistics includes an estimate of qualified rows from a first table;
the first condition is equal to the estimate of qualified rows; and
the first condition is satisfied when an actual number of qualified rows exceeds the estimate of qualified rows.

7. The method of claim 1, wherein the first command is a type of command selected from the group consisting of: an access method, a join method, and a join sequence.

8. The method of claim 1, wherein the analyzing each mini plan and the changing the access plan occur during run time.

9. The method of claim 8, wherein the generating the access plan and the creating the plurality of mini plans occur during a bind time.

10. The method of claim 1, wherein the method is performed by a query manager executing program instructions, and wherein the program instructions are downloaded from a remote data processing system.

11. A system comprising:
a processor; and
a computer-readable storage medium communicatively coupled to the processor and storing program instructions which, when executed by the processor, are configured to cause the processor to:
receive, from a host, a query that is configured to retrieve a set of data from a database;
generate an access plan, the access plan comprising a plurality of commands;
create, for a first command of the plurality of commands, a plurality of mini plans including a first mini plan and a second mini plan;
analyze each mini plan of the plurality of mini plans; and
change, dynamically and in response to the analysis, the access plan.

12. The system of claim 11, wherein:
the first mini plan is configured to execute the first command by a first method;
the second mini plan is configured to execute the first command by a second method;
the access plan is configured to execute the first mini plan; and
in response to the change of the access plan, the access plan is configured to execute the second mini plan.

13. The system of claim 11 wherein, the program instructions are further configured to cause the processor to:
determine a first condition is satisfied, wherein:
the creation of the plurality of mini plans comprises establishing the first condition; and
the change of the access plan is in response to the first condition being satisfied.

14. The system of claim 13, wherein the analysis of each mini plan is further configured to cause the processor to:
obtain a passed-in value, wherein the passed-in value is a result of a previously executed command from the plurality of commands; and
retrieve, from the database, a set of statistics related to the passed-in value.

15. The system of claim 14, wherein:
the first condition is a filter factor;
the set of statistics includes a frequency of the passed-in value in a first table; and
the first condition is satisfied when a frequency of the passed-in value exceeds the filter factor.

16. A computer program product, the computer program product comprising a computer readable storage medium having program instructions embodied therewith, the program instructions executable by a processing unit to cause the processing unit to:
receive, from a host, a query that is configured to retrieve a set of data from a database;
generate an access plan, the access plan comprising a plurality of commands;
create, for a first command of the plurality of commands, a plurality of mini plans including a first mini plan and a second mini plan;
analyze each mini plan of the plurality of mini plans; and
change, dynamically and in response to the analysis, the access plan.

17. The computer program product of claim 16, wherein:
the first mini plan is configured to execute the first command by a first method;
the second mini plan is configured to execute the first command by a second method;
the access plan is configured to execute the first mini plan; and
in response to the change of the access plan, the access plan is configured to execute the second mini plan.

18. The computer program product of claim of claim 16, wherein the program instructions are further configured to cause the processing unit to:
determine a first condition is satisfied, wherein:
the creation of the plurality of mini plans comprises establishing the first condition; and
the change of the access plan is in response to the first condition being satisfied.

19. The computer program product of claim of claim 18, wherein the analysis of each mini plan is further configured to cause the processing unit to:
obtain a passed-in value, wherein the passed-in value is a result of a previously executed command from the plurality of commands; and
retrieve, from the database, a set of statistics related to the passed-in value.

20. The computer program product of claim of claim 19, wherein:
the first condition is a filter factor;
the set of statistics includes a frequency of the passed in value in a first table; and
the first condition is satisfied when a frequency of the passed-in value exceeds the filter factor.
